(19) United States
(12) Patent Application Publication
(10) Pub. No.: US 2018/0227255 A1
(43) Pub. Date: Aug. 9, 2018

(54) METHOD AND SYSTEM FOR DISTRIBUTING DIGITAL CONTENT

(71) Applicant: AIXEP, Inc., San Francisco, CA (US)

(72) Inventors: Michael Whitmire, San Francisco, CA (US); Herve Utheza, San Francisco, CA (US); Randy Carr, San Francisco, CA (US)

(21) Appl. No.: 15/888,595

(22) Filed: Feb. 5, 2018

Related U.S. Application Data
(63) Continuation of application No. 62/454,705, filed on Feb. 3, 2017.

(51) Int. Cl. H04L 12/58; G06F 3/0482

(52) U.S. Cl. CPC H04L 51/08; G06Q 50/01; G06F 3/0482

(57) ABSTRACT

Examples provide for a user interface (UI) framework and one or more selection features to enable the user to select one or more content items for composing a data gram, receiving, from the first computing device, a data set for a composed data gram. The data gram is renderable via the UI framework. The data set includes one or more of the selected content items and metadata that associates the one or more selected content items with each of the composed data gram and a first account of a first user, and sharing the data gram with a second client account accessible via a second computing device by associating one or more of the selected content items with metadata of the second account.

### CROSS-REFERENCE

This application claims the benefit of U.S. Patent Application No. 62/454,705 filed Feb. 3, 2017, which application is hereby incorporated herein its entirety for all purposes.

### TECHNICAL FIELD

Examples described herein relate to a system and method for distributing digital content.

### BACKGROUND

Mobile computing devices are being used for creating and distributing digital content via electronic communications, including social media, email and messaging, in business and personal contexts. A significant amount of content dispatched to recipients are opened for reading on a mobile computing device, and this portion is further expected to grow. Increasingly, users utilize content sharing applications and services that allow users to interact with other users by sending and receiving various types of messages or media content (e.g., images, videos, text, etc.). For example, social network sites like FACEBOOK provide users with capabilities for forming social groups to exchange content. There exists also file sharing sites to share documents, photographs, and other types of content.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a computing and communication system configured for distributing content, in an embodiment.

FIG. 2A illustrates an example method for creating and sharing data grams.

FIG. 2B illustrates another method for sharing data grams

FIGS. 3A-3G illustrate examples of interfaces for data grams.

### DETAILED DESCRIPTION

According to examples, a computer system is provided that includes multiple computing devices of users, from which content items can be exchanged and shared. Each of the computing devices may operate an application that enables the computing device to provide functionality described with various examples. In some examples, each computing device executes an application or other program or process to implement a user interface (UI) framework, where the UI framework includes features to enable a user to select, create or modify one or more content items for composing a data gram.

In some examples, a computing device of the user can operate to receive a data set for a composed data gram, where the composed data gram is renderable via the UI framework, and the data set includes a select set of content items, as well as metadata that associates the select set of content items with each of the composed data grams, as well as a first account of a user of the composed data gram. The data gram may be shared with a second client account accessible via a second computing device by associating one or more of the selected content items with metadata of the second client account.

In some examples, a service is implemented to enable creation, modification, and/or exchange of data grams, where the service is implemented using a network computer system (e.g., server, or combinations of servers) which communicate with computing devices of users. In variations, the user computing devices can operate corresponding service applications, which implement processes to communicate with the network computer system. In such examples, the combination of the computing devices and network computer system can be implemented as a distributed architecture, on which the exchange of content using data grams can be facilitated. When implemented as a distributed architecture, the service enables individual users to collect themed content from numerous sources (e.g., other users who create or capture content that match to a theme of the data gram).

In some examples, components of the distributed architecture, such as individual user devices and/or server process used by the service, can implement rules with respect to how individual content items of a data gram can be shared and viewed. For example, a user can create content (e.g., take a picture) for a theme (e.g., landmark at favorite city, a restaurant a user wishes to learn more about, a good place to go for nightlife in a particular city, etc.). To curate content for the theme, a first user can add the content to a data gram that is specific to the theme (e.g., picture of landmark, text query about a restaurant, etc.). The service may detect the addition of the content item to the first user's data gram, and share the content item with other users who have their own data gram of the same themes, or who share the first user's data gram (or version thereof). Over time, other users may add content for the theme (e.g., other users add pictures, or text recalling a memory) to the data gram of the first user, by adding their own content to the data gram residing on their own device. According to such examples, data grams shared by users can be curated over time with user-generated content from other users, subject to permissions and other rules that enable users to control their content when shared.

In examples, each computing device may operate a service application that includes background processes to efficiently update data grams with content contributed by other users. In this way, the user can curate for content on a particular topic or subject, in order to collect content (e.g., user-generated content, such as pictures or text) about the topic. As described in greater detail with various examples, the collection, use and sharing of content can also be subject to rules of users or the service. The sharing of themed content, subject to rules which users can specify, encourages users to contribute content. Examples further recognize that curation of content can generate interest and motivate others to contribute content, resulting in a rich library of user-generated and curate content. With the framework, individual users can view content that is highly relevant to a particular theme, where the content may be updated repeatedly with addition of content items from a community of users with shared interest. Moreover, in some examples, the data grams of individual users can be updated with highly relevant content, without need of user input or direction. For example, a service application may run a background process to collect themed content contributions of other users. Thus, users can view and collect themed content without searching, or performing other manual tasks.

According to various examples, users may operate their respective devices to curate for content, using themed data grams that serve as a virtualized collection bin in which user-generated content can be collected, rendered and shared. The user-generated content can be collected from the user, or other users who share an interest related to a theme of the data gram (e.g., other users who have created or shown interest in data grams of similarly themed content). The framework, when implemented as part of the distributed architecture, enable the users to receive fresh (e.g., updated recently), original (e.g., user-generated) content that is highly relevant and specific to a theme.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

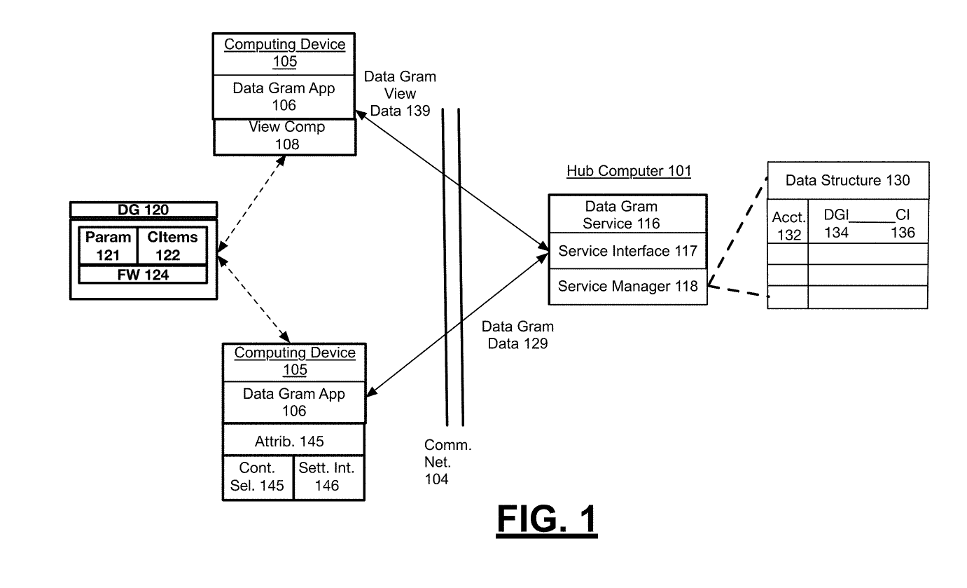

FIG. 1 illustrates a content distribution system, according to one or more examples. In FIG. 1, a content distribution system 100 can be implemented using one or more hub computers 101 which selectively communicate with multiple computing devices 105, 105 in order to enable data gram operations and functionality, as described with various examples. In some examples such as shown by FIG. 1, the hub computer 101 may be implemented by a server or by a combination of servers, to provide a network service for handling data grams (e.g., “data gram service 116”). The computing devices 105, 105 may be implemented by user-operated devices which run, for example, a service application, shown as data gram application 106, for communicating with the hub computer 101 and/or computing devices 105, 105. The computing devices 105 may execute the data gram application 106 to create, share and view data grams 120 via independent communication channels with the hub computer 101.

In variations, the computing devices 105 may utilize direct or peer-to-peer communications to exchange data grams 120 and related communications. Still further, functionality described by the server(s) or network service may be implemented by individual computing devices 105. Thus, for example, one or more computer devices 105 operated by users can also serve as the hub computer 101.

Still further, in some variations, the hub computer 101 can be used to create a data gram (e.g., as part of a data gram service). Such data grams may be referenced as system data grams, and provided to select users (or globally) via, for example. a dedicated interface element (e.g., system card).

Data Grams

In some examples, the content distribution system 100 can enable creation, viewing and sharing of data grams 120 via execution of data gram application 106 on individual computing devices 105. Each data gram 120 represents a set of content items 122 which are structured to be presented on user devices 105 under a user-interface framework 124. The content items 122 of the individual data grams 120 can be heterogeneous to type and source (e.g., a combination of text, image, video, audio, etc.). On individual computing devices 105, the data grams 106 are renderable according to a framework which provides a cohesive visual paradigm, such as a “card” for each data gram. In this way, the organizational aspects of the framework and the presentation of data grams within that framework provides an intuitive feel and experience for users in which they can generate, share and receive content more readily.

A user can operate a corresponding computing device 105 to compose and share data grams 120. The user may share the data gram 120 by selecting recipients (e.g., registered users of the data gram service), and then transmitting corresponding data gram data 129 over a communication network 104 to the hub computer 101. The hub computer 101 may receive data gram data 129 corresponding to individual data grams 120, in order to store and/or share the data grams 120 based on a corresponding action requested by the user. As described further, the hub computer 101 can implement a variety of functionality to share data grams according to rules and restrictions, which may be specified by the sender or other user.

In some examples, the data gram data 129 may include metadata that is associated with a corresponding data gram 120 as composed on a particular computing device 105. The data gram data 129 may also include content items 122 which the user selects and/or creates on the user's respective computing device 105. The data gram data 129 may include metadata in the form of an account identifier (for the sending computing device 105), a data gram identifier 134 that uniquely identifies the data gram 120, as well as a content item identifier 136 for each content item 122 that is selected for the data gram 106.

According to some examples, when a computing device 105 launches the data gram application 106, the application signals an account identifier to the hub computer 101. If the user is new to the service, the content distribution system 100 response may enable the user to establish an account (e.g., become a registered user of the data gram service). In some variations, the data gram application 106 may be launched or otherwise operated to open a wireless socket or other communication channel with the content distribution platform 101. The communication channel may be opened via the communication network 104. With the communication channel opened, the data gram application 106 may communicate, over a secure channel of the communication network 104, the user's account identifier 132 with the data gram service 116. The data gram service 116 may return, over the secure channel, data for enabling the user to access the data grams 120 which are associated with the user account. Additionally, the user may receive data gram data 129 for new data grams 120 which designate the user as a recipient.

Composing Data Grams

As described with other examples, the data gram 120 can be composed, viewed and exchanged amongst computing devices 105, 105 that utilize the data gram service 116. In some variations, the data gram application 106 can also include attribution logic 144 to attach or affix an account identifier to a composed data gram 120. Additionally, the attribution logic 144 can affix the account identifier 132 to individual content items 122 of the data gram 120, at least for some content items that the user is an originator (e.g., first user to select or specify for inclusion in the data gram 120).

In some examples, the data gram application 106 can include content selection logic 145, which can include local and/or network interfaces for enabling the user to select, create or otherwise specify content items 122 for the data gram 120. By way of example, the content selection logic 145 can include a local file interface for enabling the user to select content items (e.g., documents, text, image files, video clips, audio recordings) from local memory of the computing device 105. In addition, the components of the selection logic 145 can be optimized for mobile devices, in which the selection logic 145 can be automated to minimize content received by users to enable presentation of such content on mobile devices. The content selection logic 145 can also include device interfaces that can be selected to access a camera or audio recorder to enable the user to capture images (including video). Still further, as another example, the content selection logic 145 can include a browser component to enable the user to grab web content for inclusion in the data gram 120. Additionally, the content selection logic 145 can include a text interface to enable the user to enter text or keyboard input. The content selection interface 145 may also interface with content items which are available for selection on the data gram service 116. When data gram 120 is composed, the data gram application 106 may trigger the computing device 105 to send data gram data 129 to the hub computer 101.

In some implementations, the data gram data 129 may include the content items 122. In one implementation, when the data gram 120 is initially composed, content items 122 which are local and/or newly selected are uploaded to the hub computer 101. Previously used content items 122, on the other hand, may be specified for inclusion with a newly composed and/or data gram 120 by way of content item identifier 136, which the hub computer 101 can reference to an accessible copy (e.g., server-stored copy).

Still further, in some examples, the data gram service may create a data gram which an individual user or set of users can access or store. Such data grams may be designated for sets of users, or alternatively, for all users globally. In this way, the hub computer 101 can also ‘push’ (or send) data grams to one or more classes of users, in response to system-determined events or conditions.

In this way, the data gram 120 may include (based on user selection) one or more content items, depending on user selection, and the content items can be of different types and from different sources. The data gram 120 may further combine the collection of disparate content items within a single user interface (UI) framework 124. The UI framework 124 may provide as additional metadata, an organizational data set 131 that identifies an arrangement of the content items, as specified by the user. Additionally, the UI framework 124 can provide a rendering of the individual content items 122 according to a defined structure of the UI framework 124. In some variations, the UI framework 124 facilitates an intuitive use by which users may organize, view or share content related to an event or series of events. In this way, the UI framework 124 can include a physics engine which enables the rendering of the content items to be affected by, for example, other content items within the same UI framework 124. The physics engine may also generate organizational metadata 131 to enable replication of the desired affect amongst content items on recipient devices when the data gram 120 is shared.

In composing the data gram 120, the user may specify settings 121 that correlate to one or more usage rules for the data gram. The data gram application 106 may include a setting interface 146 which enables the user to select the one or more settings 121. In some examples, the user can interact with the setting interface 146 to specify, for example, usage rules for sharing or or otherwise accessing the data gram 120 and/or its individual content items 122. The usage rules may include permissions for sharing of content by subsequent recipients. In some examples, logic implemented at either or both of the data gram application 106 (or client side) or with the hub computer 101 (server or remote side) can be used to implement controls and other access rules which limit, for example, the ability of users to share particular data grams 120, or content items thereof. Still further, in some examples, the usage rules, such as the share permissions, can be applied persistently to the data grams 120 and/or content items 122 thereof, to regulate immediate or downstream (from first instance of sharing) sharing and/or access. For example, the composer of data gram 120 may specify settings 121 to preclude the recipient(s) from sharing the data gram. In variations, the settings 121 may preclude the recipient(s) from sharing outside of a group of recipients, or to specific individuals or groups. Still further, the settings 121 may apply to the whole data gram 120, or to portions of the data gram 120.

In other examples, the user may specify the setting 121 to restrict or limit the manner in which the data gram 120, or the content items 122 of the data gram, may be shared by others. Thus, for example, a user can specify whether a data gram 120 can be shared by the intended recipient. The share setting 121 can, for example, specify whether the recipient can re-transmit or otherwise share (i) the received data gram 120 to other recipients, (ii) some or all of the content items 122 of the data gram 120 independently of the data gram 120. In some variations, the settings 121 can restrict actions of a second recipient who receives the data gram 120 (or its content items thereof) from a previous recipient of the data gram 120. For example, the composer can specify a setting 121 in which the data gram 120 can be shared by a first recipient to a select set of second recipients, and precluding the second set of recipients from sharing the data grams to anyone else. As an addition or variation, the user can also specify whether certain content items (or none if so specified) can be shared beyond a first recipient.

In one implementation, each instance in which a given data gram 120 is shared can be conducted through the hub computer 101. The hub computer 101 can check the settings 121, and further use the data structure 130 to determine the composer, source of origin, and past or current recipients of the data gram 120. The hub computer 101 may implement the rule associated with the setting 121 in order to enable or preclude the share request from the corresponding computing device 105.

Data Gram Service

The hub computer 101 may implement a data gram service 116 for the computing devices 105. The data gram service 116 may include a service interface 117 and a service manager 118. The service interface 117 can execute to exchange communications with data gram applications 106 of computing devices. In an example of FIG. 1, the service interface 117 executes to receive the data gram data 129 transmitted over the communication network 104, and to transmit the data gram data 129 to the recipient computing device 105. The service manager 118 executes to manage receipt, storage and distribution of data grams (via the service interface 117) in accordance with usage rules, which may be specified by the settings 121 of the data gram 120.

According to some examples, the hub computer 101 may maintain a data structure 130 for use in managing and distributing the data grams. The service manager 118 may process data gram data 129 to extract attributes of individual data grams 120 and/or their respective content items 122. The attributes of the data gram 120 may be provided by the metadata of a newly composed or updated data gram 120. The attributes may include, for example, the account identifier 132 of the sending and receiving accounts, the data gram identifier 134, and the content item identifier 136 for content items 136 of the data gram 120. Additionally, the attributes for the data gram 120 may include the settings 121, which the service manager 118 may store to reference when the data gram 120 is shared or accessed. Still further, the attributes of the data gram 120 may include the organization data 131, to indicate the arrangement and/or interaction of content items 122 when the data gram 120 is rendered. Once composed, the individual data grams 120 may be stored and made accessible to the sender or recipients via the data gram service 116.

The service manager 118 may maintain and update the data structure 130 to associate a user account 132 of an individual user with a set of one or multiple data grams. For a given account 132, the data structure 130 may associate (i) data gram identifiers 134 for data grams 120 that are composed or stored by the corresponding user device 105, and (ii) data gram identifiers 134 for data grams 120 that are sent to or otherwise shared with the corresponding user device 105. The data structure 130 can also associate each data gram 120 with the content identifiers 136 of content items 122 that comprise the data gram.

In some examples, the content item identifiers 136 may reference corresponding content items 122 which are stored with the hub computer 101, or with other network accounts, sites or resources. In some variations, the content item identifiers 136 may also reference content items 122 which are locally stored.

In this way, the data structure 130 may associate an identifier 134 of the data gram 120 with an account identifier 132 where the data gram resides, as well as the content item identifiers 136 of the content items 122 that comprise the data gram 120. In some variations, the data structure 130 can also associate the data gram identifiers 134 (and/or the content item identifiers 146 of the data gram) with account identifiers 132 of the data gram composer, the recipient. Moreover, in some examples, the association described between user accounts and individual data gram 120 can be extended to individual content items which form the data gram 120. For example, the content items of the data gram 120 can be separately associated with sources, authors and/or rules.

Still further, in some examples, the data structure 130 can associate usage or access parameters with each data gram 120 and/or individual content items of each data gram. For example, the service manager 118 may extract the settings 121 from the individual data gram 120, and associate the setting 121 with the data gram identifier 134 and/or the content item identifier 136 of each data gram 120. The parameters can be based on corresponding rules, including rules for sharing, editing, composing or viewing data grams. Likewise, in some variations, the content items of each data gram can similarity be associated with usage or access parameters. The service manager 118, for example, may include functionality to distribute or otherwise enable access to individual data grams 120 based on the usage or access rules specified by the setting 121 associated with that data gram 120.

Viewing Data Grams

On the computing devices 105, the data gram application 106 may be used to view the data grams associated with the account of the computing device 105. In some examples, a viewing component 108 may be provided as a component of the data gram application 106. The viewing component 108 includes logic to render data grams 120 which are associated with the account of the particular user as, for example, thumbnails or textual identifiers. When the data gram application 106 is launched, the viewing component 108 may generate an initial request to the data gram service 116, specifying the account identifier 132 of the user. The service interface 117 may receive the request, and the service manager 118 may use the account identifier 132 to identify data gram identifiers 134 associated with the user account. A representation of at least some of the individual data grams 120 (data gram view data 139) associated with the account identifier 132 may be provided to the requesting computing device 105. The data gram application 106 may then receive data gram view data 139, corresponding to metadata, content items, and/or content item representations of individual data grams which are stored or associated with the account identifier 132. The data gram view data 139 may also identify new data grams which, for example, another user has shared with the requesting user. The viewing component 108 may use the data gram view data 139 to display representations (e.g., icons, textual identifiers, thumbnails) of the data grams 120 of the user collection according to a local library structure 108, which can sort or group data grams by, for example, category (e.g., subject matter, persons, relevant time period).

The user may interact with the data gram application 106 to view the contents of individual data grams within the corresponding UI framework 124. In one implementation, the user can select specific data grams, or sets of data grams (e.g., by category), either automatically (e.g., immediately on launch) or through selection input, to transmit data gram identifier(s) 134 to the data gram service 116. The service manager 118 may use the data structure 130 to reference the data gram identifier 134 to each of the account identifier 132, one or more content item identifiers 136, settings 121, and/or organization data 131. The data gram service 116 may return data gram view data 139 for viewing data grams on the computing device 105. The viewing component 108 of the requesting computing device 105 may use the data gram view data 139 to render the content items 122 of the selected data grams 120 in the structure of the UI framework 124.

According to some examples, the content items 122 of viewed data grams are not stored or otherwise accessible on recipient computing devices. For example, when data grams 120 are composed, the data gram service 116 may retain the content items 122, subject to sharing by default rules and/or settings 121. When the viewing component 108 implement through the respective data gram application 108 is used to view data grams, the content items may be rendered according to rules and settings managed via the data gram service 116.

User Devices

According to some examples, the computing devices 105 may correspond to consumer electronic devices that can download the data gram application 106, and subsequent updates thereof, from an “app store” and/or from a network service on which the hub computer 100 is provided. According to some examples, each computing device 105 can execute the data gram application 106 to establish a communication channel with the hub computer 101.

According to some examples, the computing devices 105, 105 may each correspond to, for example, a particular type of wireless (e.g., cellular, WiFi-enabled) multi-functional device capable of telephony, messaging, and/or Internet Protocol (IP) communications. As referred to herein, the computing devices 105 can have any of a variety of different form factors and computing platforms, such as a tablet computer device, an ultra-mobile computing device, or a wearable computing device with a form factor of a wearable accessory device (e.g., smart watch or bracelet, glass-wear integrated with a computing device, etc.). In variations, the computing devices 105 can correspond to desktop or laptop computing devices. Each computing device 105 may include a processor, a memory storing instructions and logic. The processor can implement functionality using application instructions stored in the memory. Each computing device 105 may include human interface components, such as a display screen, buttons, input sensors (e.g., touch sensitive surface or display screen) and a location determination component (e.g., Global Positioning System (“GPS”) component). Thus, the processor can receive input from various sources, including touch sensor components at the display screen, keystroke input such as from a virtual or displayed keyboard, and other input mechanisms (e.g., buttons, mouse, microphone, etc.). The computing devices 105 may also include wireless connectivity resources, such as a wireless communication receiver, a transmitter, and associated components. By way of example, the computing devices 105, 105 may include resources (e.g., transmitters, receivers) for implementing any one of multiple possible protocols, such as Wi-Fi, Bluetooth, Near Field Communication (NFC) communication protocols. The computing devices 105, 105 may implement the logic to utilize the wireless communication resources in order to establish connectivity with a server or computing device of the content distribution system.

As multi-functional devices, computing devices 105, 105 may include one or more of email, messaging, calendaring or telephony software applications for execution thereon. The data gram application 106 may encompass any one or more of an email communication interface, an instant messaging communication interface, a calendar event invitation communication interface, and a telephone communication interface. One or more of the third-party applications may provide functionality which integrates with aspects or functionality of the client application.

Methodology

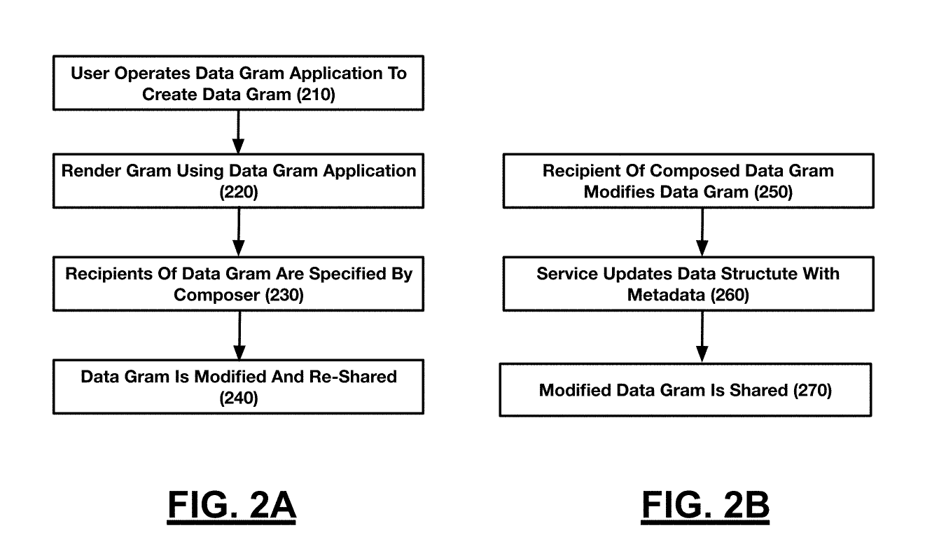

FIG. 2A illustrates an example method for creating and sharing data grams. FIG. 2B illustrates another method for sharing data grams. In describing examples of FIG. 2A and FIG. 2B, reference may be made to an example of FIG. 1 for purposes of illustrating suitable components or elements for performing a step or sub-step being described.

At a first computing device 102, a user operates the data gram application 106 to create a data gram 120 (210). The data gram application 106 executes content selection logic 135 to enable the user to select one or more content items for composing a data gram 120. The content may be selected from, for example, local memory (e.g., file folders), sensor devices of the computing device 105 (e.g., camera, audio recorder), input from other interfaces of the computing device 102, and/or remote sources (e.g., web page, other data grams stored with the data gram service 116).

The composed data gram 120 may be rendered on the computing device 105 via the service application 106 (220). The data gram 120 may include a data set that includes one or more content items, and metadata associated with the one or more content items. As described with other examples, the meta data may include an account identifier 132 of the composer, a data gram identifier 134, and one or more content item identifiers 136. The metadata may also include settings 121 to control access and sharing of the data gram 120. Additionally, the metadata may include organizational data 131, which define a manner in which content items 122 are organized within the particular data gram 120.

The user may specify one or more other recipients to receive the data gram 120 (230). For example, the user specifies a particular user (e.g., by account identifier, moniker, etc.), or a group of users. To share the data gram, the data gram application 106 transmits the data gram data 129 to the data gram service 116, and the service manager 118 updates the data structure 130 to link the data gram 120 with the accounts of the recipient. For example, the service manager 118 may link the data gram identifier 134, the content item identifiers 136 of the corresponding data gram, the account of the composing user, and the account of the recipients. The data gram service 116 may then transmit the corresponding data gram data 129 to the computing devices 105 of the identified recipient accounts.

According to some examples, the composed data gram 120 may be subsequently modified and re-shared (240). In some examples, the data gram 120 may be modified and re-transmitted by the composing user to previous recipients or new recipients. In variations, the data gram 120 may be modified and re-transmitted by recipients of the original data gram 120. The modifications may include addition of, change to, or deletion of content items 122 which are associated with the data gram 120, as well as change the organization data 131 of the data gram 120. The composer of the data gram 120 may also change the settings 121 (e.g., share permissions) associated with the data gram 120.

With reference to FIG. 2B, data gram 120 may be composed and provided to a recipient, who may then modify the data gram (250). The modified data gram 128 may be created by, for example, the recipient user operating the data gram application 106 running on the second computing device 105. The recipient user may modify the data gram 120 by, for example, adding or substituting content items to the data gram 120, in order to create a new modified data gram 128. The modified data gram 128 may be provided a new data gram identifier 134, or utilize the prior data gram identifier 134.

The data gram service 116 may update the data structure 130 by associating the content item identifiers 136 with the data gram identifier 134 of the modified data gram 120 (260). The data gram 120 can then be shared (270) with the original recipients, or with a subset of the recipients (e.g., just the original composer). Still further, the modifier may select to share the data gram 120 with one or more new recipients. In sharing the data gram, the modified data gram 120 may also carry restrictions, such as some of the content items 122 may be restricted by the original composer.

In some implementations, the content items 122 of the modified data gram 120 may also identify the account identifier 132 of the original sender, as well as the recipient. In some variations, the data gram service 116 can track the origin of the content items 122, to enable the settings 121 to be specific to content items, and specified by an original composer who placed the content item with a particular data gram. The settings 121 may limit, for example, the first recipient of the data gram, or alternatively, limit the first recipient from sharing the data gram, or still further, limit the second recipients (who receive the data gram 120 from the first recipient) from sharing the data gram 120.

In accordance with the method, sharing the data gram may be accomplished by enabling, for example, a user of first computing device 102 to specify the share setting 121 for the data gram. The service manager 118 may implement the share setting in, for example, permitting or denying a particular activity. Still further the service manager 118 may include data to trigger functionality of the data gram application 106 on recipient computing devices. The triggered functionality may limit the manner in which the content items are rendered, viewed or used by the recipient computing device, such that access and distribution of the content item 122 remains under control as specified by the settings 121.

Thus, in one example, the second computing device 105 may be enabled to share a composed data gram with a third computing device when the share setting 121 (as specified by a user of the sending computing device 105) permits the second computing device to share the composed data gram with a third computing device or any subsequent computing device. In one variation, the share setting 121 may be designated as not specific to any computing device. In variations, the share setting 121 may be specifically applicable to a group of computing devices, or alternatively, specifically applicable to a third computing device. In another variation, the share setting 121 may preclude the second computing device to share the composed data gram with a third client.

Yet further, the share setting may designate or specify a first share rule or permission for a first content item of the composed data gram, and yet a second share rule or permission for a second content item of the composed data gram. In variations, the first share rule may enable a first content item 122 of the data gram 120 to be shared or restricted from sharing under a first share setting, and a second content item 122 of the data gram 120 to be shared or restricted from sharing under a second share setting.

### EXAMPLES

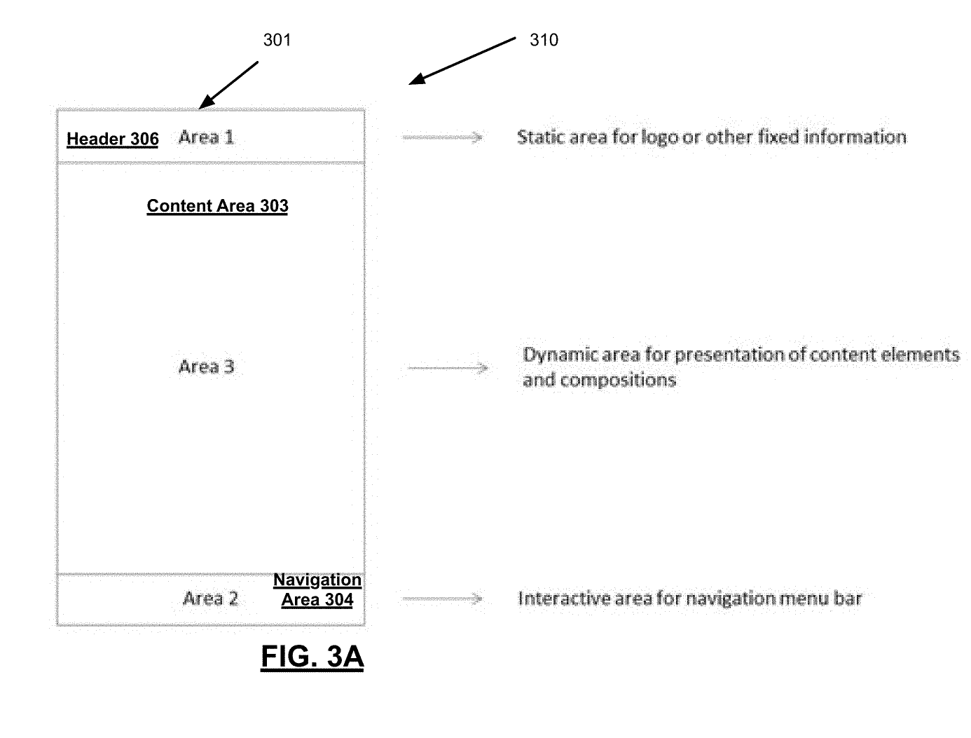

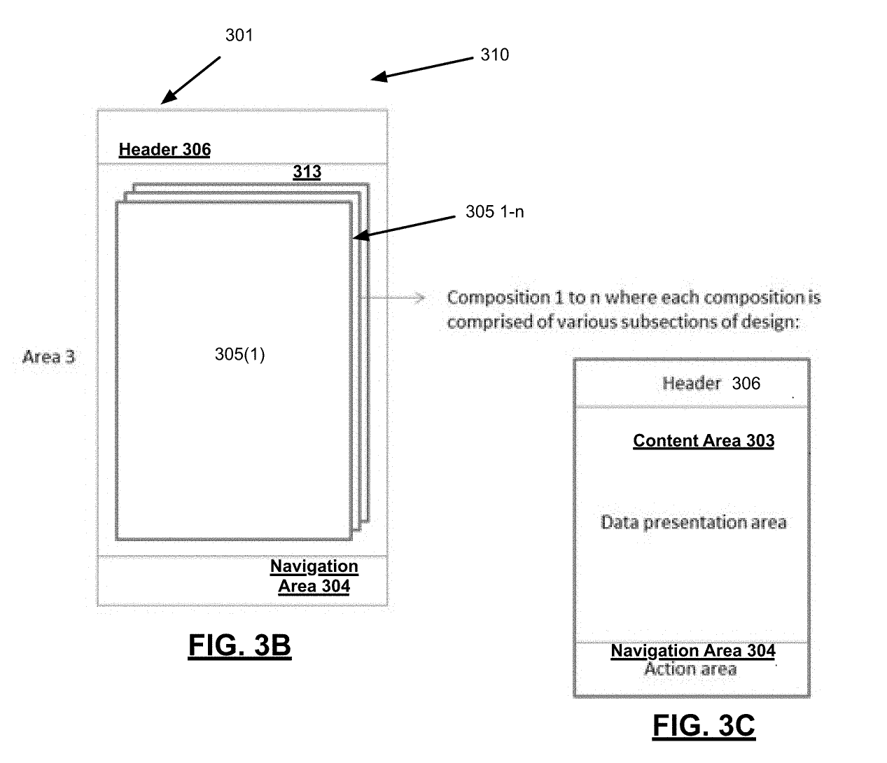

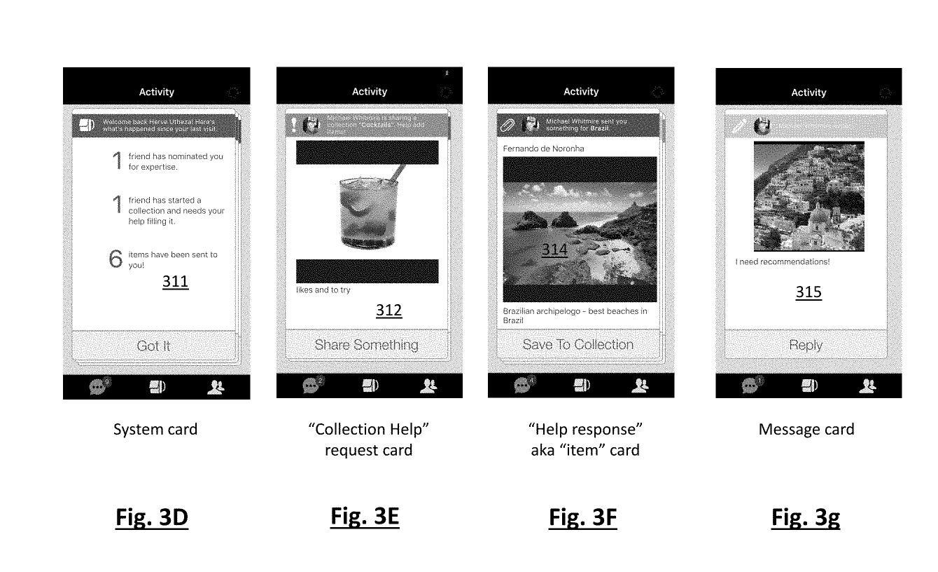

FIGS. 3A through 3G illustrate alternative examples of a user interface for rendering data grams on a display screen of a computing device 105. With reference to an example of FIG. 1, example user interfaces of FIG. 3A through FIG. 3G may be implemented through execution of data gram application 106. Accordingly, reference is made to elements of FIG. 1 for purpose of illustrating suitable components for implementing functionality as described.

In FIG. 3A, a data gram interface 310 includes a UI framework 301, content area 303, navigation menu bar area 304 and fixed information (or header information) area 306 for a given data gram 120. The content area 303 displays content items 122 which are associated with the data gram. For example, some or all of the content items may be downloaded from the data gram service 116. In some variations, the content area 303 may display content items associated with the data gram 120 without persistently storing the individual content items on the computing device 105. For example, once the user terminates a session with the data gram service 116, the content items 122 may become unavailable to other programmatic resources of the computing device 105.

In an example of FIG. 3B, the data gram interface 310 displays data gram viewing data 139 using the UI framework 301, which further implements a card stack representation 315 in which multiple data grams (n) 305 are arranged for selection and viewing. In this arrangement, UI framework 301 maintains a stack area 313 (which may correspond to the content area 303) for selection of data grams. By way of the card stack 315, one or more accessible (e.g., composed, viewed) data grams 305 of the card stack are selectable over other data grams of the stack by way of a particular type of input action (e.g., swiping gesture action performed upon a touch screen of the computing device 105). For example, in implementing the card stack arrangement 315 with the data gram interface 310, the data gram application 106 may implement rules which determine the sequence in the arrangement of the data grams (e.g., most recently viewed data grams at top), the manner in which content of individual data grams are displayed when in the stack, and/or a virtualization for navigating amongst cards (e.g., shuffling). When one of the data grams 305 of the card stack 315 is displayed, FIG. 3C illustrates that the contents of the selected data gram 305 are rendered under the UI framework 301.

In an example of FIG. 3D, the data gram interface 310 displays a system data gram 311. The system data gram 311 may display information about the data grams that are associated with the user account, using the UI framework 301 (including content display area 303, navigation menu bar 304 and header 306).

FIG. 3E and FIG. 3F each illustrate an implementation in which a user designates a data gram for collection of information provided by others. The respective data grams 312, 314 can be composed to include content items (e.g., text, images, audio, video). The user may use the navigation area 304 to share data grams 312, 314 with, for example, a group of recipients.

FIG. 3G illustrates an implementation in which a user may modify a data gram. For example, a recipient of one of the data grams 312, 314 may select to generate a reply data gram 315 to communicate content which the composer was requesting. In this way, recipients can add to the data gram, so the data gram is modified. However, the data gram remains associated with the sender. When the new content item is added to the data gram, a corresponding content identifier may be generated and linked to the existing data gram identifier 134. The composer and recipients who were originally associated with the particular data gram 305 may then view the added content item.

In variations, the recipient who adds the content item for the collection may specify settings to limit the sharing of the added content item. Thus, the settings 121 may be provided by the recipient, and linked to the content identifier 136 and the data gram identifier 134.

Still further, the reply data gram may be generated as a new data gram, with a corresponding data gram identifier. The data gram identifier may be associated with other users who are specified by the composer of the recipient data gram 315. Thus, the recipient may be able to provide a response for the composer of the data grams 312, 314 using a new data gram.

According to some examples, the data grams may be composed to include a particular format (e.g., layout) or functionality (e.g., share, reply, help). In related embodiments, the data gram may include one or more ancillary information postings pertinent to a topic to which the data gram relates, such as, but not limited to, a message posting, an email posting, a website log posting or a cumulative score ranking associated with the composed content items or the data gram.

Although illustrative embodiments have been described in detail herein with reference to the accompanying drawings, variations to specific embodiments and details are contemplated and encompassed by this disclosure. For instance, it is contemplated that aspects described in context of the communications inbox herein may be adapted to a standalone application which acts in conjunction with email, calendar, messaging and other communications applications. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method of distributing content, the method executed in a processor of a computing device, the computing device including a memory storing instructions, the method comprising:
providing, at a first computing device, a user interface (UI) framework and one or more selection features to enable a user to select one or more content items for composing a data gram;
receiving, from the first computing device, a data set for a composed data gram, the composed data gram being renderable via the UI framework, the data set including one or more of the selected content items and metadata that associates the one or more selected content items with each of the composed data gram and a first account of a first user of the composed data gram; and
sharing the data gram with a second client account accessible via a second computing device by associating one or more of the selected content items with metadata of the second client account.

2. The method of claim 1 wherein a content item of the data gram includes at least one of alphanumeric text, graphic symbols, a photograph, a song and a video.

3. The method of claim 1 wherein at least one of the first and second computing devices is a mobile wireless device.

4. The method of claim 1 wherein the data gram comprises a wire frame representation having at least a title area, a content area, and a navigation options area, at least a portion of a content item being rendered within the content area.

5. The method of claim 4 wherein the data gram comprises a card frame representation.

6. The method of claim 1 wherein the data gram includes one or more ancillary information postings, the one or more ancillary information postings including at least one of message posting, an email posting, a website log posting or a cumulative score ranking associated with a composed content item.

7. The method of claim 1 wherein the UI framework is a card frame representation.

8. The method of claim 7 wherein the UI framework includes a card stack representation depicting a plurality of composed data grams, the composed data grams of the card stack being selectable over other data grams by way of a gesture action performed upon a gesture interface of the second computing device.

9. The method of claim 1 further comprising:
receiving, from a second computing device associated with the second client account, a modification to at least one selected content item of the composed data gram to produce a modified data gram; and
storing the at least one selected content item in association with the modified data gram and the second client account.

10. The method of claim 9 wherein the at least one selected content item is stored for rendering as part of the modified data gram on a computing device of the second client account, in accordance with the UI framework.

11. The method of claim 9 wherein the modified data gram retains an associated one or more ancillary information postings included with the composed data gram, the one or more ancillary information postings including at least one of a message posting, an email posting and a website log posting.

12. The method of claim 1, wherein sharing the data gram includes:
enabling the user of the first computing device to specify a share setting for the data gram; and
implementing the share setting on the second computing device.

13. The method of claim 12, further comprising enabling the second computing device to share the composed data gram with a third computing device when the share setting permits the second computing device to share the composed data gram with the third computing device.

14. The method of claim 12, wherein the share setting is not specific to any computing device, specific to a group of computing devices, or specific to a third computing device.

15. The method of claim 12, further comprising precluding the second computing device to share the composed data gram with a third computing device based on the share setting.

16. The method of claim 12, wherein the share setting specifies a first share rule for a first content item of the composed data gram, and a second share rule for a second content item of the composed data gram.

17. The method of claim 16, wherein the first share rule enables the first content item of the data gram to be shared or restricted from sharing under a first share setting, and the second content item of the data gram to be shared or restricted from sharing under a second share setting.

18. A system for creating and distributing digital content items comprising:
a processor; and
a memory storing instructions, the instructions being executable by the processor the processor to:
provide, at a first computing device, a user interface (UI) framework and one or more selection features to enable a user to select one or more content items for composing a data gram;
receive, from the first computing device, a data set for a composed data gram, the composed data gram being renderable via the UI framework, the data set including one or more of the selected content items and metadata that associates the one or more selected content items with each of the composed data gram and a first account of a first user of the composed data gram; and
share the data gram with a second client account accessible via a second computing device by associating one or more of the selected content items with metadata of the second client account.

19. The system of claim 18 wherein at least one of the first and second computing devices is a mobile wireless device.

20. The system of claim 18 wherein the memory further stores instructions executable by the processor to:
enable the user of the first computing device to specify a share setting for the data gram; and
implement the share setting on the second computing device.
